(19) United States
(12) Patent Application Publication
(10) Pub. No.: US 2017/0193083 A1
(43) Pub. Date: Jul. 6, 2017

(54) IDENTIFYING MESSAGE CONTENT RELATED TO AN EVENT UTILIZING NATURAL LANGUAGE PROCESSING AND PERFORMING AN ACTION PERTAINING TO THE EVENT

(71) Applicant: International Business Machines Corporation, Armonk, NY (US)

(72) Inventors: Dhruv A. Bhatt, Indian Trail, NC (US); Kristin E. McNeil, Charlotte, NC (US); Soomi Mun, Stallings, NC (US); Nitaben A. Patel, Charlotte, NC (US)

(21) Appl. No.: 14/988,974

(22) Filed: Jan. 6, 2016

(51) Int. Cl. G06F 17/30; G06Q 10/10

(52) U.S. Cl. CPC G06F 17/30663; G06F 17/30719; G06Q 10/1095; G06F 17/30368

(57) ABSTRACT

A first message comprising first unstructured text can be received. A determination can be made as to whether at least a first content of the first unstructured text is related to an event by processing the first unstructured text using natural language processing. Responsive to determining that the first content is related to the event, the first content can be extracted from the first message and stored to a data storage. At least a second message comprising second unstructured text can be received. At least a second content of the second unstructured text can be identified and a determination can be made as to whether the second content is related to the event by processing the second unstructured text using natural language processing. Responsive to determining that the second content is related to the event, at least one action pertaining to the event can be performed.

### BACKGROUND

The present invention relates to electronic communications, and more specifically, to electronic messaging.

Electronic mail (e-mail) clients and online social networks are used universally to connect people and information in logical and organized ways, enabling information to be shared among the users. The most common mechanisms of sharing and processing information are email client inboxes and social network walls, activity streams, timelines and profiles. These mechanisms enable people to rapidly share information with, and gather information from, other people.

### SUMMARY

A method includes receiving a first message comprising first unstructured text. The method also can include determining whether at least a first content of the first unstructured text is related to an event by processing, using a processor, the first unstructured text using natural language processing. The method also can include, responsive to determining that the first content is related to the event, extracting the first content from the first message and storing the first content, separate from the first message, to a data storage. The method also can include receiving at least a second message comprising second unstructured text. The method also can include identifying at least a second content of the second unstructured text and determining whether the second content is related to the event by processing the second unstructured text using natural language processing. The method also can include, responsive to determining that the second content is related to the event, performing at least one action pertaining to the event.

A system includes a processor programmed to initiate executable operations. The executable operations include receiving a first message comprising first unstructured text. The executable operations also can include determining whether at least a first content of the first unstructured text is related to an event by processing the first unstructured text using natural language processing. The executable operations also can include, responsive to determining that the first content is related to the event, extracting the first content from the first message and storing the first content, separate from the first message, to a data storage. The executable operations also can include receiving at least a second message comprising second unstructured text. The executable operations also can include identifying at least a second content of the second unstructured text and determining whether the second content is related to the event by processing the second unstructured text using natural language processing. The executable operations also can include, responsive to determining that the second content is related to the event, performing at least one action pertaining to the event.

A computer program includes a computer readable storage medium having program code stored thereon. The program code is executable by a processor to perform a method. The method includes receiving, by the processor, a first message comprising first unstructured text. The method also can include determining whether at least a first content of the first unstructured text is related to an event by processing, by the processor, the first unstructured text using natural language processing. The method also can include, responsive to determining that the first content is related to the event, extracting, by the processor, the first content from the first message and storing the first content, separate from the first message, to a data storage. The method also can include receiving, by the processor, at least a second message comprising second unstructured text. The method also can include identifying, by the processor, at least a second content of the second unstructured text and determining, by the processor, whether the second content is related to the event by processing the second unstructured text using natural language processing. The method also can include, responsive to determining that the second content is related to the event, performing, by the processor, at least one action pertaining to the event.

### BRIEF DESCRIPTION OF THE DRAWINGS

FIG. 1 is a block diagram illustrating an example of a computing environment.

FIG. 2 is a flow chart illustrating an example of a method of identifying and storing event details contained in a message.

FIG. 3 is a flow chart illustrating an example of a method of implementing one or more actions in response to receiving one or more messages pertaining to an event.

FIG. 4 is a block diagram illustrating example architecture for a messaging system.

FIG. 5 is a block diagram illustrating example architecture for a client device.

### DETAILED DESCRIPTION

The present invention relates to electronic communications, and more specifically, to electronic messaging. In accordance with the inventive arrangements disclosed herein, a first user can send to a plurality of other users a message pertaining to an event. The other users can respond to the first message by sending additional messages. A messaging system can perform natural language processing (NLP) and semantic analysis on each of the messages to identify content contained in the messages that are related to the event. Responsive to identifying such content, the messaging system can perform one or more actions. Example of such actions may include, but are not limited to, summarizing open questions pertaining to the event, summarizing event details, identifying popular answers, generating response lists, automatically sending reminder messages, updating calendars, and the like.

Several definitions that apply throughout this document now will be presented.

As defined herein, the term “unstructured text” means text communicated in a message using a human language, and which is not organized in a predefined manner.

As defined herein, the term “human language” is a language spoken or written by human beings that is not a computer programing language. A “human language” may be referred to as a “natural language.”

As defined herein, the term “natural language analysis” means a process that derives a computer understandable meaning unstructured text.

As defined herein, the term “message” means an e-mail communicated by one user to one or more other users, a text message communicated by one user to one or more other users, or information posted by a user in a web-based forum to be shared with one or more other users. A message may include text, one or more images and/or one or multimedia content.

As defined herein, the term “e-mail” means an electronic mail delivered via a communication network to at least one user. An e-mail may be sent by one user to one or more other users. In this regard, an e-mail typically identifies at least recipient using a user name (e.g., e-mail address) corresponding to the recipient, or a group name corresponding to a group of recipients, in at least field within the e-mail, for example within a “To” field, “Cc” field and/or “Bcc” field in a header of the e-mail. A recipient may view an e-mail via an e-mail client, which may execute on a client device or a server to which a client device is communicatively linked.

As defined herein, the term “text message” means an electronic message comprising text delivered via a communication network to at least one user identified as a recipient. A text message may be sent by one user to one or more other users. In this regard, a text message typically identifies at least one recipient using a user name, telephone number or the like. A text message also may comprise audio, image and/or multimedia content. A text message can be delivered, for example, using the short message service (SMS), the text messaging service (TMS) and/or the multimedia messaging service (MMS). A text message also may be referred to as an “instant message.” As defined herein, a text message itself is not a result generated by an Internet search engine per se, although a text message may contain one or more uniform resource identifiers, such as hyperlinks, which can be generated by an Internet search engine and copied, for example by a user (e.g., sender), into the text message. In this regard, if a user uses a web browser to access an Internet search engine to perform an Internet search, and the user receives results from the Internet search engine in the web browser, such results are not a text message as the term text message is defined herein.

As defined herein, the term “web-based forum” means is an online discussion site where people can post messages that are viewable by other people. For example, people can hold conversations in a web-based forum by posting messages. Some messages posted in a web-based forum may be responses to other posted messages, or ask questions related to other posted messages. A web-based forum can be, for example, a social networking site, which is an online service platform on which social networks or social relations are built among people who, for example, share interests, activities, backgrounds or real-life connections.

As defined herein, the term “post” means to enter a message in a thread of a web-based forum. A new thread can be created in which to enter the message, or the message can be entered into an existing thread.

As defined herein, the term “message stream” means series of related messages. Examples of a message stream include a message thread within a social networking system, a series of exchanged e-mails and a series of exchanged text messages. A message stream can include a topic message and one or more messages replying to the topic message or responding to other messages within the message stream.

As defined herein, the term “natural language analysis” means a process that derives a computer understandable meaning of a human language.

As defined herein, the term “human language” is a language spoken or written by human beings that is not a computer programing language. A “human language” may be referred to as a “natural language.”

As defined herein, the term “client device” means a processing system including at least one processor and memory that requests shared services from a server, and with which a user directly interacts. Examples of a client device include, but are not limited to, a workstation, a desktop computer, a mobile computer, a laptop computer, a netbook computer, a tablet computer, a smart phone, a digital personal assistant, a smart watch, smart glasses, a gaming device, a set-top box and the like. Network infrastructure, such as routers, firewalls, switches, and the like, are not client devices as the term “client device” is defined herein.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

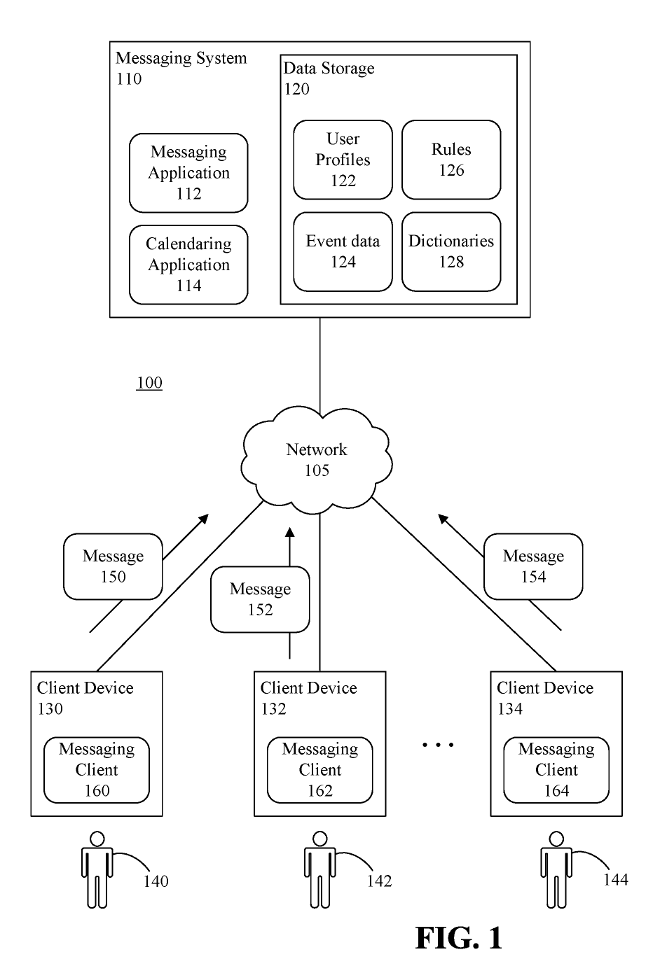

FIG. 1 is a block diagram illustrating an example of a computing environment 100 in which the inventive arrangements may be implemented. The computing environment 100 contains a network 105. The network 105 is the medium used to provide communications links between various devices and data processing systems connected together within computing environment 100. The network 105 may include connections, such as wire, wireless communication links, or fiber optic cables. The network 105 may be implemented as, or include, any of a variety of different communication technologies such as a Wide Area Network (WAN), a Local Area Network (LAN), a wireless network, a mobile or cellular network, a Virtual Private Network (VPN), the Internet, the Public Switched Telephone Network (PSTN), or the like.

The computing environment 100 also can include a messaging system 110 and a plurality of client devices 130, 132, 134, each of which may be coupled to the network 105. In this regard, the client devices 130-134 can couple to the messaging system 110 using respective communication links established via the network 105 to send and receive messages 150, 152, 154 via the messaging system 110.

The messaging system 110 may be implemented as one or more data processing systems (e.g., servers), each including at least one processor and memory, executing suitable software to support the sharing and/or exchange of messages. In illustration, the messaging system 110 can execute a messaging application 112, which can be an e-mail server, an instant messaging server or a web-based forum. The messaging system 110 also can include a calendaring application 114. In one arrangement, the calendaring application 114 can be a component of the messaging system 110, though the present arrangements are not limited in this regard.

The messaging system 110 also can include a data storage 120. The data storage 120 can include one or more data tables or other data storage structures, and can be contained on a computer-readable storage medium integrated with, or otherwise coupled to, the messaging system 110. The data storage 120 can store user profiles 122, event data 124, rules 126 and one or more dictionaries 128. The user profiles 122 can be user profiles of users 140, 142, 144 of the messaging system 110, who can use the messing system 110 via respective client devices 130-134. The user profiles 122 can include user identification information, user preferences, and the like.

The event data 124 can be data corresponding to events identified in content of one or more messages 150, 152, 154 sent by the users 140-144, as will be described. The rules 126 can include various rules that define the manner in which content is parsed from the messages 150-154, operations to be performed by the messaging system 110 in response to identifying the content, etc., as also will be described. The dictionaries 128 can be configured to be used by the messaging application 112 when performing natural language processing (NLP) and semantic analysis on the messages to identify content in the messages corresponding to events, questions, responses to questions, and the like.

NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. An unstructured information management architecture (UIMA), which is an industry standard for content analytics, may be used by the messaging application 112 to implement NLP and semantic analysis.

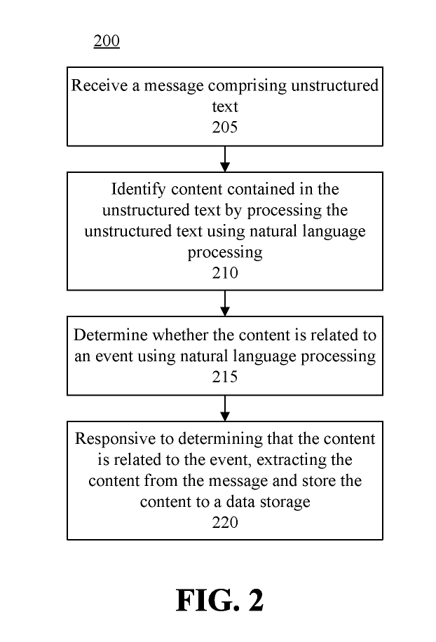

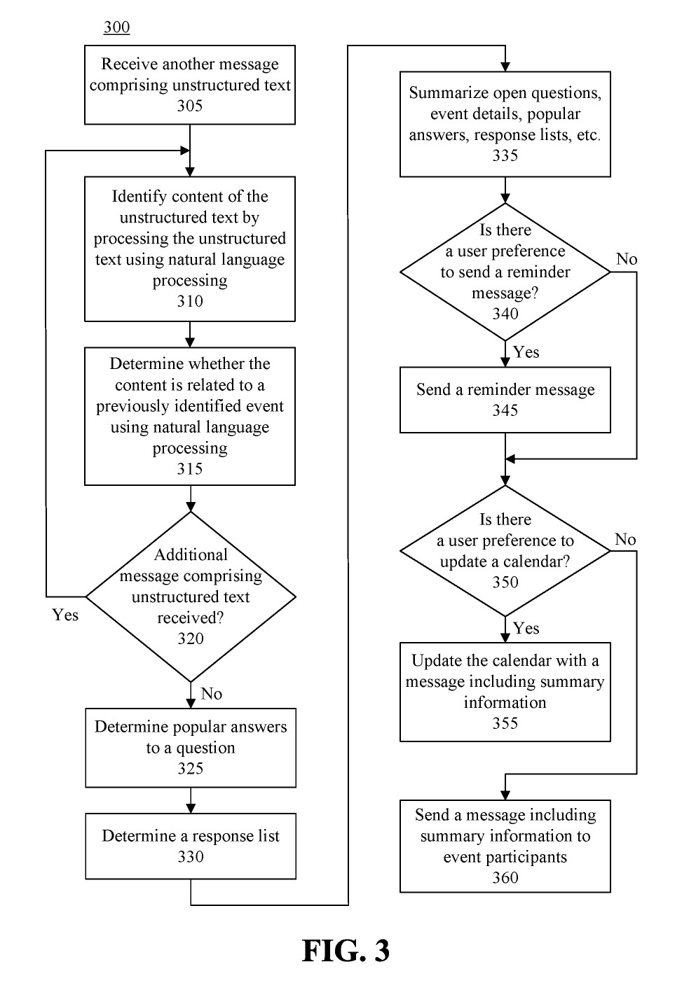

In one arrangement, each of the client devices 130-134 can include a respective messaging client 160, 162, 164, for example an e-mail client and/or a text messaging client, used to generate the messages 150-154 and communicate the messages 150-154 to the messaging system 110. In addition to, or in lieu of, the messaging clients 160-164, the client devices 130-134 can include web browsers and/or mobile applications via which the client devices 130-134 interface with the messaging system 110 to generate and communicate the messages 150-154. For example, via a web browser and/or mobile application, the user 140 can access a web-based forum and post messages to the web-based forum, or the user 140 can access a messaging client interface hosted by the messaging system 110 to generate and communicate e-mails and/or text messages. Various operations that may be performed by the messaging system 110 in response to receiving the messages 150-154 are described in FIGS. 2 and 3.

FIG. 2 is a flow chart illustrating an example of a method 200 of identifying and storing event details contained in a message. Referring to FIGS. 1 and 2, at step 205, the messaging application 112 can receive a message 150, generated by the user 140, from the client device 130. The message can comprise unstructured text. In the case that the message 150 is a post to a web-based forum, the messaging application 112 can post the message 150 to a web-based forum. In the case that the message 150 is an e-mail or text message, the messaging application 112 can forward the message 150 to the recipients (e.g., to the users 142, 144 of the client devices 132, 134), or store the message 150 to be retrieved by the client devices 132, 134.

At step 210, the messaging application 112 can identify, in real time, content contained in the unstructured text by processing the unstructured text using natural language processing. Such identification can be performed by the messaging application 112 processing the content using NLP, and may include the messaging application 112 also performing semantic analysis on the content. At step 215, the messaging application 112 can determine, in real time, whether the content is related to an event. Such determination also can be performed using NLP and semantic analysis on the content. For example, the messaging application 112 can correlate words or phrases contained in the content to entries in one or more of the dictionaries 128 and, based on such correlation, identify entries that indicate words or phrases that are events. In illustration, if a phrase in the content includes the term “go to lunch,” the messaging application 112 can identify “go to lunch” as an event. There are a myriad of other events that can be identified in this manner, and the present arrangements are not limited in this regard.

At step 220, responsive to determining that the content is related to an event, the messaging application 112 can, in real time, extract the content relating to the event from the message 150 and store the content to the data storage, for example as event data 124. To extract the content, the messaging application 112 can copy the content from the unstructured text, thus leaving the original message 150 intact. In this regard, the extracted content can be stored as event data 124 that is separate from the actual message 150. By way of example, the message 150 can contain the following text: “Who wants to go to lunch? Any suggestions on where to go?” Thus, the message application 112 can identify the event “go to lunch” and the question “Any suggestions on where to go” as relating to the event. The messaging application 112 can create a record in the event data 124 comprising a plurality of fields, store the event “go to lunch” in a first field (e.g., an event field) and store the question “Any suggestions on where to go” in a second field (e.g., an inquiry field). Still, the messaging application 112 can identify any other information related to the event and store that information in other fields of the record.

FIG. 3 is a flow chart illustrating an example of a method 300 of implementing one or more actions in response to receiving one or more messages pertaining to an event. Referring to FIGS. 1 and 3, at step 305, the messaging application 112 can receive another message 152 comprising unstructured text. The message 152, for example, can be sent by the user 142 and can be a response to the message 150 and/or be a message that includes as a recipient the user 140 who sent of the message 150. For example, the message 152 can be contained in the same message stream as the message 150. At step 310, the messaging application 112 can identify, in real time, content contained in the unstructured text by processing the unstructured text using NLP. Such processing also may include performing semantic analysis on the unstructured text.

At step 315, the messaging application 112 can determine, in real time, whether the content is related to a previously identified event, for example an event identified at step 215 of FIG. 2. Such identification can be performed by the messaging application 112 processing the content using NLP, and may include the messaging application 112 also performing semantic analysis on the content. In illustration, the messaging application 112 can identify that the message 152 is a response to the message 150 and/or a message that includes as a recipient the user 140 who sent of the message 150, and that the message 152 includes content pertaining to the identified event. For example, the message can include the word “lunch” or an identifier of a restaurant (e.g., Joe's Diner). Using the dictionaries 128, the messaging application 112 can determine that the term “Diner” indicates a restaurant where users may go to lunch. Similarly, if the messaging application 112 can identify other content related to the event, for example a suggested time, who has volunteered to drive, etc. If the content is related to the previously identified content, the messaging application 112 can store words or phrases from the content in the event data 124 in a manner that associates the content with the identified event. For example, the messaging application 112 can create one or more records in which to store the content and link the record(s) to the record previously created for the event.

At decision box 320, the messaging application 112 can determine whether additional messages comprising unstructured text are received, or may be received. If so, for example a message 152 is received, the messaging application 112 can return to step 310 and continue the process of steps 310-320. The messaging application 112 can continue the process of steps 310-320 for a pre-determined interval, continue the process of steps 310-320 until each of the users 140, 142 who received the message 150 have sent response messages 150, 152, or continue the process of steps 310-320 until a threshold number of the users 140, 142 who received the message 150 have sent response messages 150, 152. The threshold number can be, for example, a predetermined percentage of the users 142, 144 who received the message 150.

Referring again to decision box 320, responsive to the messaging application 112 determining the pre-determined interval has expired, determining that each of the users 140, 142 who received the message 150 have sent a response message 152, 154, or determining that a threshold number of the users 140, 142 who received the message 150 have sent a response message 152, 154, the messaging application 112 can perform at least one action pertaining to the event. For example, the process implemented by the messaging application 112 can proceed to step 325. At this point it should be noted that some users 140, 142 may respond to the message 150 after the process proceeds to step 325. In one aspect of the present arrangements, determinations made by the messaging application 112 in one or more of the following steps can be updated in response to receiving such additional messages.

At step 325, the messaging application 112 can determine popular answers to a question. For example, if the message 150 asked “Any suggestions on where to go,” the messaging application 112 can determine a most popular answer to the question and, optionally, other answers that also are popular. For instance, if three of the messages 152, 154 respond with “Joe's Diner” and two of the messages 152, 154 respond with “Tina's Cafe,” the messaging application 112 can determine that “Joe's Diner” is the most popular answer, and “Tina's Cafe” is the second most popular answer.

At step 330, the messaging application 112 can determine a response list. The response list can include the user 140 who sent the message 150. The response list also can include each of the users 142, 144 who sent response messages 152, 154 or each of the users 140, 142 who are listed as recipients of the message 150.

At step 335, the messaging application 112 can summarize the content contained in the messages 150-154 to generate summary information for the event. For example, the messaging application can summarize open questions (e.g., “Any suggestions on where to go”), event details (e.g., “go to lunch,” dates/times that may be indicated, who has offered to drive, etc.), popular answers, response lists, etc. Steps 340-360 describe various examples of how the messaging application 112 can communicate the summary information and other information to one or more of the users 140-144. In this regard, the processes described for decision boxes 340, 350 and steps 345, 355, 360 can be performed, independently, for each user 140-144.

In illustration, at decision box 340 the messaging application 112 can determine if the user 140 has a preference for the messaging application 112 to send a reminder message. The messaging application 112 can access the user's user profile 122 to determine the user's preference. If the user 140 has a preference for the messaging application 112 to send a reminder message, at step 345 the messaging application 112 can send a reminder message. The reminder message can remind the user 140 of the event, any open questions that need to be answered, any open items that need to be completed, the aforementioned summary information (e.g., popular answers, etc.), and/or the like. By way of example, if the event is going to lunch, the messaging application 112 can send the reminder message at a predetermined time or a time that is a predetermined duration before a scheduled time of the event. The messaging application 112 can determine when to send the reminder message based on the user preferences.

At decision box 350, the messaging application 112 can determine whether there is a user preference to update an electronic calendar (hereinafter “calendar”), for example to update the calendar with information for the event. Again, the messaging application 112 can access the user's user profile 122 to determine the user's preference. If the user has a preference to update a calendar, at step 355 the messaging application 112 can update the user's calendar. For example, if the user's calendar is maintained by the calendaring application 114, the messaging application 112 can communicate to the calendaring application 114 data to update the user's calendar. The calendaring application 114 can add an entry into the user's calendar accordingly. If the user profile 122 of the user 140 indicates that the user's calendar is maintained by another application, for example on another server or on the client device 130, the messaging application 112 can communicate to such application a message including data to be processed by such other application to update the user's calendar. The application can add an entry into the user's calendar accordingly.

The data sent by the messaging application 112 to update the user's calendar can include information related to the event. For example, the data can indicate the event, a date/time of the event, and the aforementioned summary information. The date/time can be determined by the content extracted from one or more of the messages 150-154. For example, if the message 150 proposes a date/time for the event, that date/time can be indicated in the data, and the calendar application 114 or other application can create a calendar entry on that date/time. If the message 150 only proposes a time, the data can indicate the next occurrence of that time. For example, if the message 150 is sent at 4:00 P.M. and indicates a time of 10:30 A.M., the date/time can be assumed to be 10:30 A.M. of the next day and the data can indicate such time. Further, if one or more of the messages 152-154 propose a new date/time, the messaging application 112 can determine, based on the content contained in the messages 152-154, whether the new date/time is agreed upon by processing the messages 152-154 using NLP and semantic analysis. If so, the data can indicate the new date/time.

Referring again to decision box 350, if the user does not have a preference to update a calendar, at step 360 the messaging application 112 can send a message to the user. Such message can include the information related to the event. For example, the message can indicate the event, the date/time of the event, and the aforementioned summary information. The date/time of the event can be determined as previously described.

In some cases, new messaged pertaining to an event may be received after the processes described in the steps 325-335, 345, 355, 360 and decision boxes 340, 350 have been performed. In such cases, the processes described in the steps 325-335, 345, 355, 360 and decision boxes 340, 350 can be repeated to update the summary information, update calendar entries, send additional messages, etc.

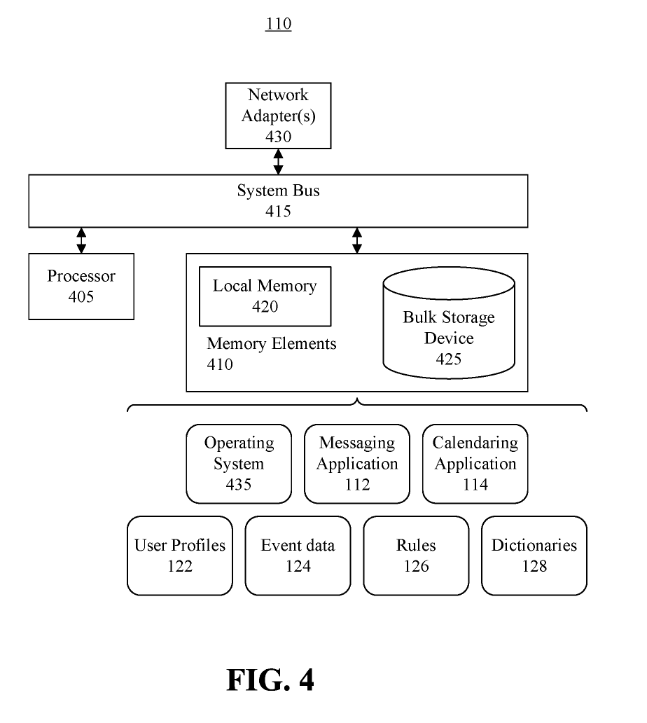

FIG. 4 is a block diagram illustrating an example architecture for the messaging system 110 of FIG. 1. The messaging system 110 can include at least one processor 405 (e.g., a central processing unit) coupled to memory elements 410 through a system bus 415 or other suitable circuitry. As such, the messaging system 110 can store program code within the memory elements 410. The processor 405 can execute the program code accessed from the memory elements 410 via the system bus 415. It should be appreciated that the messaging system 110 can be implemented in the form of any system including a processor and memory that is capable of performing the functions and/or operations described within this specification that are performed by the messaging system 110. For example, the messaging system 110 can be implemented as one or more hardware servers.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), or other persistent data storage device. The messaging system 110 also can include one or more cache memories (not shown) that provide temporary storage of at least some program code in order to reduce the number of times program code must be retrieved from the bulk storage device 425 during execution.

One or more network adapters 430 can be coupled to messaging system 110 to enable the messaging system 110 to become coupled to other systems, client devices, computer systems, remote printers, and/or remote storage devices through intervening private or public networks. Modems, cable modems, transceivers, and Ethernet cards are examples of different types of network adapters 430 that can be used with the messaging system 110.

As pictured in FIG. 4, the memory elements 410 can store components of the messaging system 110, for example an operating system 435, and the messaging application 112, calendaring application 114, user profiles 122, event data 124, rules 126 and dictionaries 128 depicted in FIG. 1. As noted, in another arrangement, the user profiles 122, event data 124, rules 126 and dictionaries 128 can be stored on another device or system that is coupled to the messaging system 110. Being implemented in the form of executable program code, the operating system 435, messaging application 112 and calendaring application 114 can be executed by the processor 405. For example, the processor 405 can execute the messaging application 112 and calendaring application 114 within a computing environment provided by the operating system 435 in order to perform the processes described herein that are performed by the messaging system 110. Further, the processor 405 can access data from the user profiles 122, event data 124, rules 126 and dictionaries 128 to perform the process described herein. As such, the operating system 435, messaging application 112, calendaring application 114, user profiles 122, event data 124, rules 126 and dictionaries 128 can be considered part of the messaging system 110. Moreover, the operating system 435, messaging application 112, calendaring application 114, user profiles 122, event data 124, rules 126 and dictionaries 128 are functional data structures that impart functionality when employed as part of the messaging system 110.

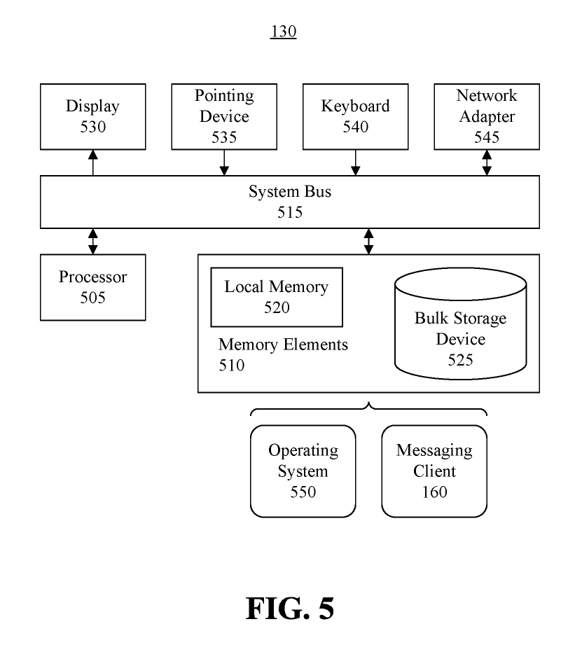

FIG. 5 is a block diagram illustrating an example architecture for the client device 130 of FIG. 1. The client devices 132, 134 can include similar architecture. The client device 130 can include at least one processor 505 (e.g., a central processing unit) coupled to memory elements 510 through a system bus 515 or other suitable circuitry. As such, the client device 130 can store program code within the memory elements 510. The processor 505 can execute the program code accessed from the memory elements 510 via the system bus 515. It should be appreciated that the client device 130 can be implemented in the form of any system including a processor and memory that is capable of performing the functions and/or operations described within this specification that are performed by the client device 130.

The memory elements 510 can include one or more physical memory devices such as, for example, local memory 520 and one or more bulk storage devices 525. The client device 130 also can include one or more cache memories (not shown) that provide temporary storage of at least some program code in order to reduce the number of times program code must be retrieved from the bulk storage device 525 during execution.

Input/output (I/O) devices such as a display (or touchscreen) 530, a pointing device 535 and, optionally, a keyboard 540 can be coupled to the client device 130. The I/O devices can be coupled to the client device 130 either directly or through intervening I/O controllers. For example, the display 530 can be coupled to the client device 130 via a graphics processing unit (GPU), which may be a component of the processor 505 or a discrete device. At least one network adapter 545 also can be coupled to client device 130 to enable the client device 130 to become coupled to other systems, computer systems, remote printers, and/or remote storage devices through intervening private or public networks.

As pictured in FIG. 5, the memory elements 510 can store the components of the client device 130, for example an operating system 550 and the messaging client 160 of FIG. 1. Being implemented in the form of executable program code, the operating system 550 and the messaging client 160 can be executed by the processor 505. For example, the processor 505 can execute the messaging client 160 within a computing environment provided by the operating system 550 in order to perform the processes described herein that are performed by the client device 130. As such, the operating system 550 and the messaging client 160 can be considered part of the client device 130. Moreover, the operating system 550 and the messaging client 160 are functional data structures that impart functionality when employed as part of the client device 130.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a first message comprising first unstructured text;
determining whether at least a first content of the first unstructured text is related to an event by processing, using a processor, the first unstructured text using natural language processing;
responsive to determining that the first content is related to the event, extracting the first content from the first message and storing the first content, separate from the first message, to a data storage;
receiving at least a second message comprising second unstructured text;
identifying at least a second content of the second unstructured text and determining whether the second content is related to the event by processing the second unstructured text using natural language processing; and
responsive to determining that the second content is related to the event, performing at least one action pertaining to the event.

2. The method of claim 1, wherein performing at least one action pertaining to the event comprises:
determining at least one answer to at least one question contained in the first content by processing at least the second content using natural language processing; and
communicating the at least one answer to at least one user by sending the user a third message or updating a calendar of the user.

3. The method of claim 2, wherein the at least one answer comprises an answer that is most popular among a plurality of other users.

4. The method of claim 1, wherein performing at least one action pertaining to the event comprises:
updating an electronic calendar of at least one user to include information for the event identified in at least the second content.

5. The method of claim 1, wherein performing at least one action pertaining to the event comprises:
summarizing at least the second content to generate summary information for the event.

6. The method of claim 5, wherein performing at least one action pertaining to the event further comprises:
updating an electronic calendar of at least one user to include the summary information for the event.

7. The method of claim 5, wherein performing at least one action pertaining to the event further comprises:
communicating to at least one user a message comprising the summary information for the event.

8. A system, comprising:
a processor programmed to initiate executable operations comprising:
receiving a first message comprising first unstructured text;
determining whether at least a first content of the first unstructured text is related to an event by processing the first unstructured text using natural language processing;
responsive to determining that the first content is related to the event, extracting the first content from the first message and storing the first content, separate from the first message, to a data storage;
receiving at least a second message comprising second unstructured text;
identifying at least a second content of the second unstructured text and determining whether the second content is related to the event by processing the second unstructured text using natural language processing; and
responsive to determining that the second content is related to the event, performing at least one action pertaining to the event.

9. The system of claim 8, wherein performing at least one action pertaining to the event comprises:
determining at least one answer to at least one question contained in the first content by processing at least the second content using natural language processing; and
communicating the at least one answer to at least one user by sending the user a third message or updating a calendar of the user.

10. The system of claim 9, wherein the at least one answer comprises an answer that is most popular among a plurality of other users.

11. The system of claim 8, wherein performing at least one action pertaining to the event comprises:
updating an electronic calendar of at least one user to include information for the event identified in at least the second content.

12. The system of claim 8, wherein performing at least one action pertaining to the event comprises:
summarizing at least the second content to generate summary information for the event.

13. The system of claim 12, wherein performing at least one action pertaining to the event further comprises:
updating an electronic calendar of at least one user to include the summary information for the event.

14. The system of claim 12, wherein performing at least one action pertaining to the event further comprises:
communicating to at least one user a message comprising the summary information for the event.

15. A computer program product comprising a computer readable storage medium having program code stored thereon, the program code executable by a processor to perform a method comprising:
Receiving, by the processor, a first message comprising first unstructured text;
determining whether at least a first content of the first unstructured text is related to an event by processing, by the processor, the first unstructured text using natural language processing;
responsive to determining that the first content is related to the event, extracting, by the processor, the first content from the first message and storing the first content, separate from the first message, to a data storage;
receiving, by the processor, at least a second message comprising second unstructured text;
identifying, by the processor, at least a second content of the second unstructured text and determining, by the processor, whether the second content is related to the event by processing the second unstructured text using natural language processing; and
responsive to determining that the second content is related to the event, performing, by the processor, at least one action pertaining to the event.

16. The computer program product of claim 15, wherein performing at least one action pertaining to the event comprises:
determining at least one answer to at least one question contained in the first content by processing at least the second content using natural language processing; and
communicating the at least one answer to at least one user by sending the user a third message or updating a calendar of the user.

17. The computer program product of claim 16, wherein the at least one answer comprises an answer that is most popular among a plurality of other users.

18. The computer program product of claim 15, wherein performing at least one action pertaining to the event comprises:
updating an electronic calendar of at least one user to include information for the event identified in at least the second content.

19. The computer program product of claim 15, wherein performing at least one action pertaining to the event comprises:
summarizing at least the second content to generate summary information for the event.

20. The computer program product of claim 19, wherein performing at least one action pertaining to the event further comprises:
updating an electronic calendar of at least one user to include the summary information for the event or communicating to the at least one user a message comprising the summary information for the event.
